(19) United States
(12) Patent Application Publication
(10) Pub. No.: US 2017/0300306 A1
(43) Pub. Date: Oct. 19, 2017

(54) ACCELERATED PARSING IN A VIRTUAL MACHINE FOR SIMILAR JAVASCRIPT CODES IN WEBPAGES

(71) Applicant: Qualcomm Innovation Center, Inc., San Diego, CA (US)

(72) Inventors: Subrato Kumar De, San Diego, CA (US); Zaheer Ahmad, San Diego, CA (US); Sajo Sunder George, San Diego, CA (US)

(21) Appl. No.: 15/265,638

(22) Filed: Sep. 14, 2016

Related U.S. Application Data
(60) Provisional application No. 62/321,931, filed on Apr. 13, 2016.

(51) Int. Cl. G06F 9/45

(52) U.S. Cl. CPC G06F 8/427

(57) ABSTRACT

A method and computing device for generating an intermediate representation of received source code for compiling or interpreting on the computing device are disclosed. The method may include receiving source code at the computing device and finding similar source code cached on the computing device that is not the same as the received source code. The received source code is compared to the similar source code to determine one or more differences between the received source code and the similar source code. Metadata for the similar source code is accessed, an intermediate representation of the cached source code is retrieved, and the intermediate representation of the cached source code is first copied and the copy is modified using the one or more differences in connection with the metadata to generate an intermediate representation for the received source code.

### CLAIM OF PRIORITY UNDER 35 U.S.C. §119

The present Application for Patent claims priority to Provisional Application No. 62/321,931 entitled “ACCELERATED PARSING IN A VIRTUAL MACHINE FOR NEAR SIMILAR JAVASCRIPT CODES IN WEBPAGES” filed Apr. 13, 2016, and assigned to the assignee hereof and hereby expressly incorporated by reference herein.

### BACKGROUND

### Field

The present invention relates to computing devices. In particular, but not by way of limitation, the present invention relates to processing scripting language content on mobile devices including tablets.

### Background

More and more websites are utilizing ECMAscript-based scripting languages (e.g., JavaScript or Flash) in connection with the content that they host. For example, JavaScript-based content is ubiquitous, and JavaScripts are run by a JavaScript engine that may be realized by a variety of technologies including interpretation-type engines, HotSpot just-in-time (JIT) compilation (e.g., trace based or function based), and traditional-function-based JIT compilation where native code is generated for the entire body of all the functions that gets executed.

JavaScript execution is a central component of a web browser, accounting as much as 20-40% of the page loading time. Script source code needs to be parsed dynamically at runtime and converted into an intermediate representation (IR) (e.g., abstract-syntax-tree (AST), bytecode, or others forms) and it accounts for a noticeable portion (10%-70%) of the entire JavaScript time, depending on the nature of the code.

JavaScript parsing becomes a performance bottleneck as large Web applications become dominant with few hundred thousand lines of JavaScript code in them. To improve JavaScript time, JavaScript virtual machines typically use intermediate representation caching to avoid parsing the same JavaScript code again when revisiting the same webpage (or visiting other webpages using the same shared JavaScript library).

The current state of the art can bypass the JavaScript parsing time when the new JavaScript code is an exact match with a previously encountered JavaScript code and use its cached intermediate representation directly. But if there is a slight difference (e.g., even a single character difference) between two similar JavaScript codes, the entire parsing step needs to be done from scratch and the cached intermediate representation cannot be used.

As used herein, the term “similar” is used for two pieces of source code that are not an exact clone—they are similar in structure, but there are some differences (e.g., different variable and function names, different constant or string values, and maybe some simple difference in operations). Thus, similar JavaScript code still encounters the full parsing overhead and does not benefit from current caching mechanisms. As a consequence, improved apparatus and methods that reduce the time associated with scripting-language processing are desired.

### SUMMARY

An aspect includes a method for generating an intermediate representation of received source code for compiling or interpreting on a computing device. The method may include receiving source code at the computing device and if no exact match with any existing cached source code is found, the method involves finding similar source code cached on the computing device that may not be an exact match with the received source code. The received source code is compared to the similar source code to determine one or more differences between the received source code and the similar source code. Metadata for the similar source code is accessed, an intermediate representation of the cached source code is retrieved and copied, and the copy of the intermediate representation of the cached source code is modified using the one or more differences in connection with the metadata to generate an intermediate representation for the received source code.

### BRIEF DESCRIPTION OF THE DRAWINGS

FIG. 1 is a block diagram of a computing device;

FIG. 2 is a flowchart depicting a method for generating an intermediate representation of source code;

FIG. 3 is a process flow diagram depicting an exemplary process for creating metadata for source code;

FIG. 4 is a drawing including tables depicting exemplary rules for generating metadata;

FIG. 5 depicts exemplary metadata;

FIG. 6 depicts an exemplary similar tracking table;

FIG. 7 is a process flow diagram depicting processes for similarity determination and intermediate code generation; and

FIG. 8 is a block diagram depicting hardware components that may be used to realize the embodiments disclosed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

In several embodiments, the time it takes to load webpages is substantially reduced by reducing the parsing time of scripting-language code (e.g., JavaScript code) in those webpages. For example, embodiments disclosed herein reduce the parsing time for JavaScript “code B,” which is similar to another JavaScript “code A” that has been already parsed and has cached the intermediate representation (e.g., abstract-syntax-tree (AST), bytecode, or others forms) of the source code. The source code differences between two pieces of source code (referred to as “code A” and “code B”), and the cached intermediate representation (IR) for code A, may be used to short-circuit the creation of the intermediate representation for code B without doing any extensive parsing of JavaScript code B, thereby drastically cutting the parsing time for JavaScript code B. Other methods applicable to static C/C++ compilers (i.e., standard approaches to detect function clones) do not help because they themselves need to do the full parsing (which is beneficial to avoid).

The cached source code 132 and received source code 104 may in the form as written by a code developer manually (with comments, spaces, tabs, and other artificial artifacts), or it may also exist in the simplified or preprocessed or compressed form where the code comments, white spaces, tabs, and various other cosmetic artifacts of writing code that do not impact the effective source code can be stripped off. The source code difference module 124 can have various optional configurations where it can be set up to partially or fully not consider these cosmetic artifacts as differences when it is computing the source code difference.

Similar pieces of JavaScript code may be encountered when: JavaScript code dynamically modifies small parts of current code A; the new modified code B is largely the same as code A except for small differences; different websites use slightly modified versions of common JavaScript libraries and frameworks (so browsers visiting the two different sites will encounter similar JavaScript codes).

For convenience, many embodiments and operational aspects of the present invention are described in the context of JavaScript code that is processed by one or more varieties of JavaScript engines that compile JavaScript code, but the methodologies and inventive constructs described herein are certainly applicable to other types of code (e.g., both existing and yet to be developed coding schemes) that are compiled during runtime.

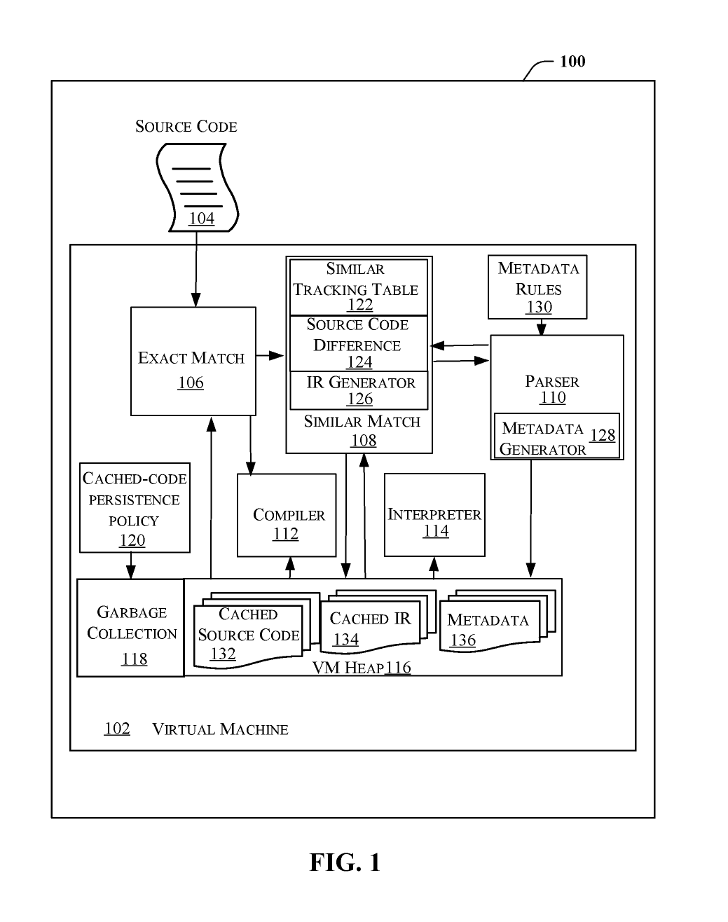

Referring first to FIG. 1, shown is a block diagram depicting an exemplary computing device 100 in which many embodiments of the present invention may be implemented. The computing device 100 is generally configured to communicate via a network to remote web servers or proxy servers (not shown) to receive and display content (e.g., webpages) for a user of the computing device 100. The computing device 100 may be realized by a wireless communication device (WCD) such as a smartphone, PDA, netbook, tablet, laptop computer and other wireless devices. But the computing device 100 may work in tandem with wireline and wireless computing devices. The computing device 100 may network with other devices and servers via the Internet, local area networks, cellular networks (e.g., CDMA, GPRS, and UMTS networks), WiFi networks, and other types of communication networks.

As depicted, the computing device 100 in this embodiment includes a virtual machine 102 that is disposed to receive and process source code 104 so the instructions embodied in the source code 104 may be processed more quickly than prior art virtual machines. The source code 104 is generally in a dynamically-typed language such as JavaScript, LISP, SELF, Python, Perl, or ActionScript. The source code 104 may represent, for example, a website, a program, or an application, or any other computer instructions that may be written in dynamically-typed code.

The virtual machine 102 may be realized by modifying a compilation-type engine, an interpreter engine, or a combination of both types of engines. In one embodiment, the depicted virtual machine 102 is realized by modifying a HotSpot™ just-in-time (JIT) compiler, which is a compiler for dynamically-typed languages. But it is contemplated that many kinds of compilation or interpretation engines, or hybrids of the two, may be modified in various embodiments without departing from the scope of the disclosure.

In this embodiment, the virtual machine 102 includes an exact-match module 106, a similar match module 108, a parser 110, a compiler 112, an interpreter 114, a virtual machine (VM) heap 116, a garbage collection module 118, and cached-code persistence policy 120. In addition, the similar match module 108 includes a similar tracking table 122, a source code difference module 124, and an intermediate representation generator 126. The parser 110 in this embodiment includes a metadata generator 128 and coupled to the parser 110 are metadata rules 130. Also depicted within the VM heap 116 are cached source code 132, cached intermediate representation (IR) code 134, and metadata 136.

The illustrated arrangement of the components depicted in FIG. 1 is logical, the connections between the various components are exemplary only, and the depiction of this embodiment is not meant to be an actual hardware diagram; thus, the components can be combined or further separated in an actual implementation, and the components can be connected in a variety of ways without changing the basic operation of the system. For example, the functional components depicted as the similar tracking table 122, source code difference module 124, and intermediate representation generator 126 are shown as components of the similar match module 108, but the functional component may be realized by constructs that are distributed among other components depicted in FIG. 1.

Although not depicted in FIG. 1, the virtual machine 102 may be implemented in connection with a browser that provides typical browser functions such as parsing HTML, rendering, and compositing webpage content for presentation to the user of the computing device 100. Other browser functions include providing a user interface, bookmarking and cookie management, and management of web page history. In some embodiments for example, the browser may include a browser core realized by a WebKit browser core, but this is certainly not required and other types of browser cores may be utilized. Such a browser may be realized by a variety of different types of browsers known to those of ordinary skill in the art including Safari, Explorer, Chrome, and Android browsers.

In general, the exact match module 106 operates, as in known in the art, to bypass the parsing of new received source code 104 when there is an exact match (of the received source code 104) with a cached source code 132. When there is an exact match, the cached intermediate representation of the source code is used directly. But if there is a slight difference (e.g., even a single character difference) between two pieces JavaScript source code, the similar match module 108 is engaged.

In contrast to the exact match module 106, the similar match module 108 generally operates to determine whether source code is a similar match with source code that has already been parsed and has corresponding cached IR code (that is copied and then modified and used) to avoid the time consuming process of parsing the received source code.

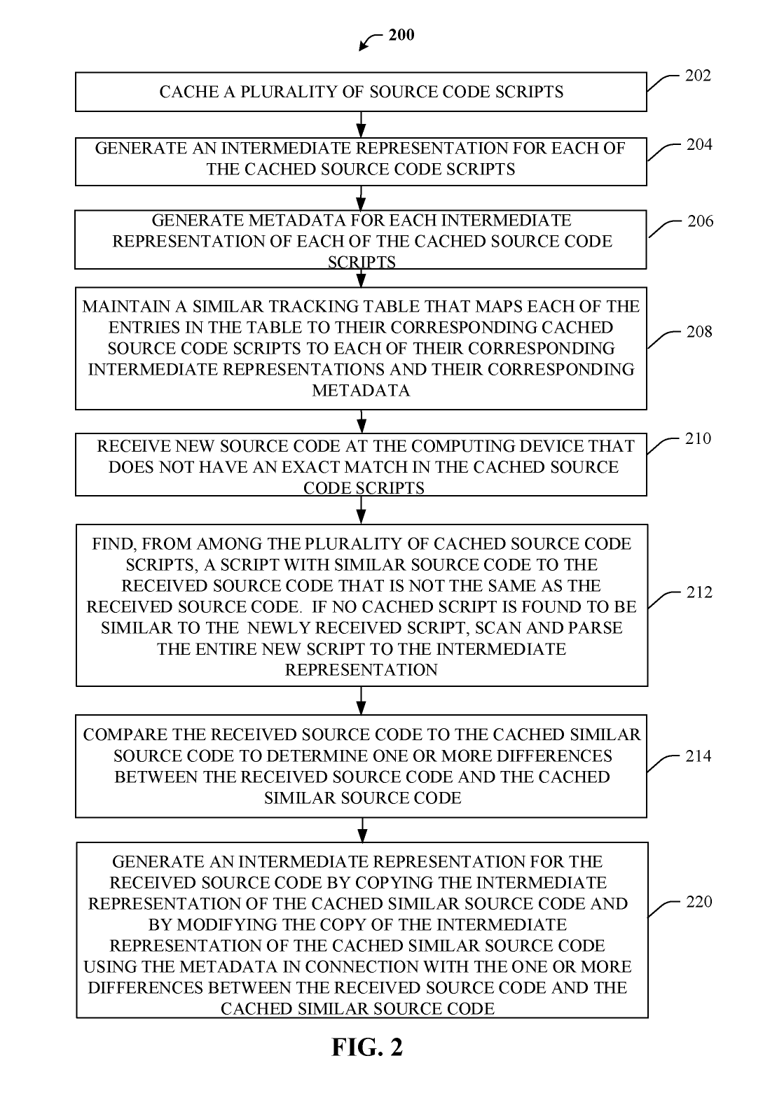

While referring to FIG. 1, simultaneous reference is made to FIG. 2, which is a flowchart depicting a method that may be traversed in connection with the embodiment depicted in FIG. 1. It should be recognized that in implementation, steps need not be carried out in the same order as depicted in FIG. 2. It should also be recognized that a particular step depicted in FIG. 2 need not be carried out all at once; thus FIG. 2 is not intended to represent the process flow of executable code—it is instead intended to capture activities that occur (e.g., over an extended period of time) in connection with aspects described in more detail further herein. For example, a plurality of source code scripts is cached to form the cached source code 132 (Block 202), but the caching of the source code scripts may occur sequentially over several days or weeks. Similarly, an intermediate representation of each of the cached source code scripts 132 is generated and stored in the VM heap 116 to form the cached IR 134 (Block 204), but the generation of each of the intermediate representations in the cached IR 134 may occur sequentially over several days or weeks. Likewise, metadata for intermediate representations of one or more of the cached source code scripts 132 is generated (Block 206) over a period of time when the source code is received and cached. It is to be noted that not all cached scripts may want to keep the metadata for them, particularly if that cached script does not want to participate in the similarity matching process. It may be because the script is not useful for the purpose.

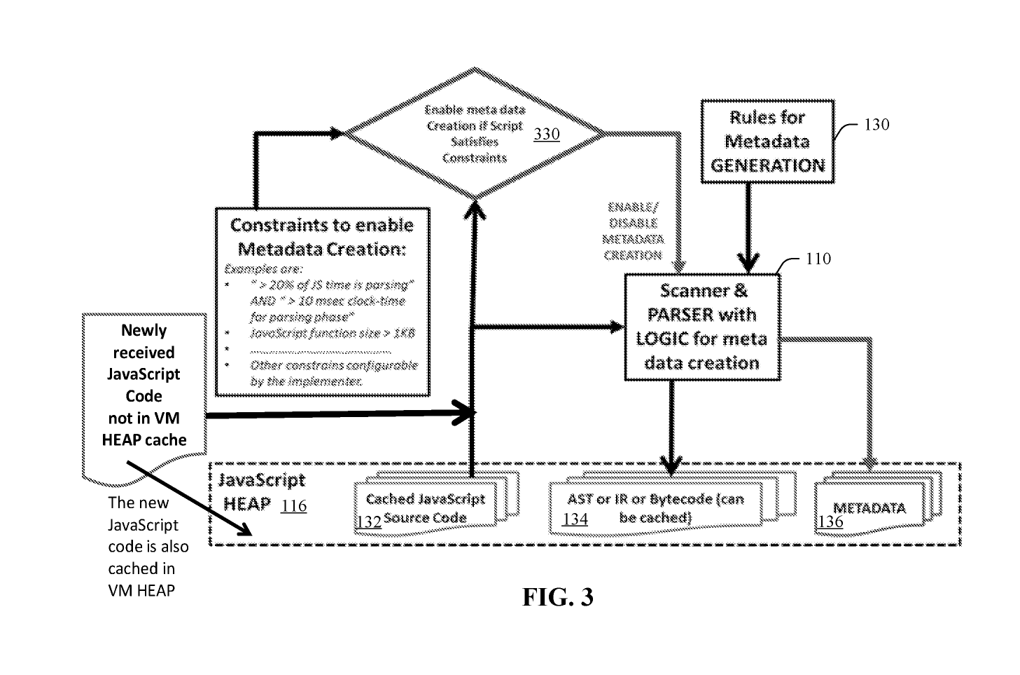

Referring to FIG. 3, shown is a process flow diagram depicting actions that may be carried over time to create the cached source code (Block 202), the cached IR 134 (Block 204), and the metadata 136 (Block 206). As shown in FIG. 3, when newly received source code (that is not in the VM heap 116) is received, the new source code is cached in the VM heap 116 (among other pieces of source code scripts in the cached source code 132).

According to an aspect, before metadata is created, a determination is made as to whether one or more constraints are met (Block 330). More specifically, the methodology may be applied to selective JavaScript code scope (e.g., function, global, inner) that take a noticeable (e.g., from human-user's perspective) time to parse. A heuristic parameter may be used that can be tunable by an implementation. For example, and without limitation, one or more of the following constraints indicative of a time it takes to parse the source code (in various combinations) may be used:
Greater than 20% of a time to process and execute source code is parsing;
Greater than 10 milliseconds of clock-time are used for the parsing phase;
The source code (e.g., JavaScript) function size is greater than 1 KB; and/or
Other constraints that may be configurable by implementation.

For the selected JavaScript code scopes, the intermediate representation (e.g., AST or bytecode) is cached. The duration of caching and type of caching may vary (and may be configurable). For example, the duration and type of caching may be persistent across browser sessions or just for the particular browsing process life (which could be few hours to days until a process is killed or the computing device 100 is rebooted). The garbage collection policy 120 of the implementation may also be configurable to decide when to delete the cached IR 134.

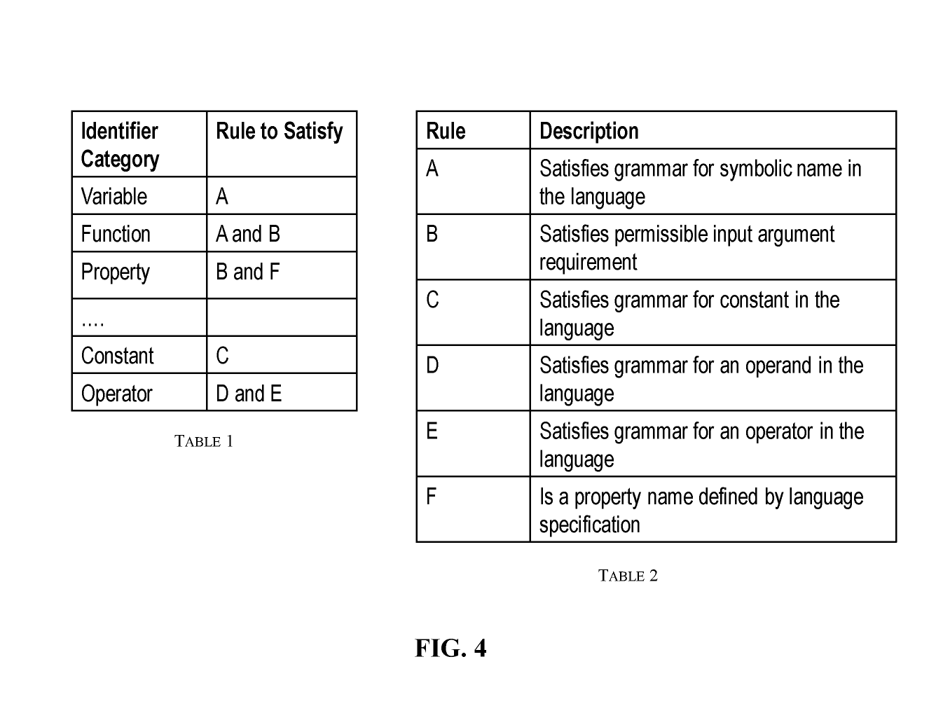

For the selected JavaScript source code scopes, metadata 136 is created using the metadata rules 130. Referring briefly to FIG. 4, for example, shown are two tables. Table 1 includes an identifier category that denotes the various identifiers categories and rules relative to permissible variables, functions, properties, constants, and operators in the input source code language for the program, e.g., a JavaScript program. Table 2 includes a plurality of rules (rules A-F) and a description of each of the rules.

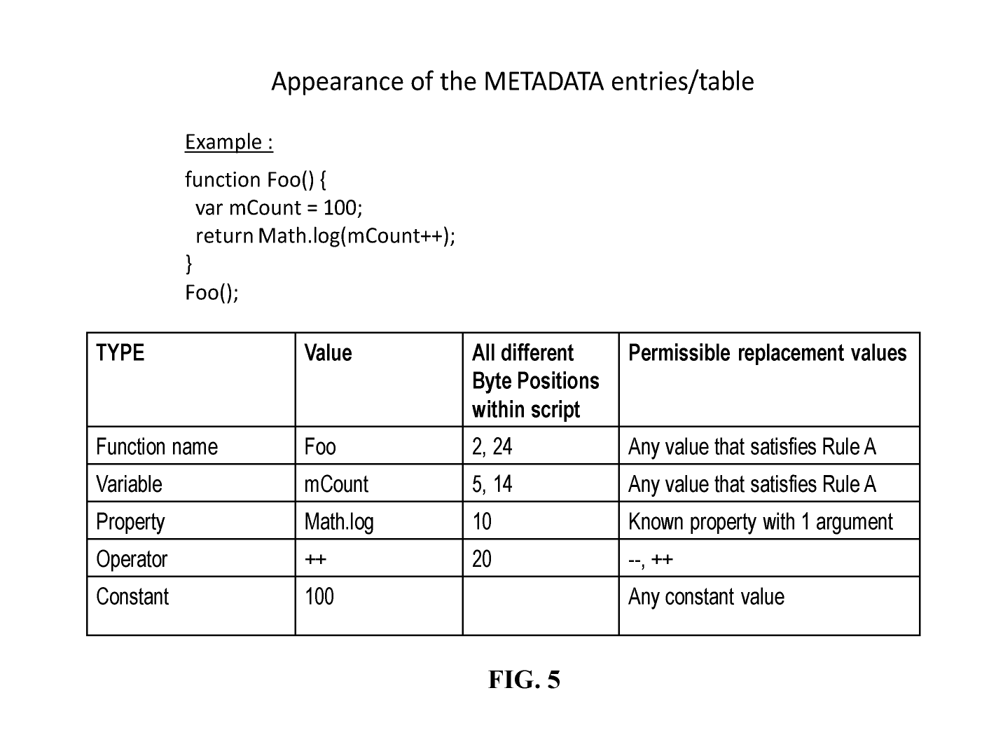

The metadata 136 that is created identifies certain parts of the cached IR 134 and maps the source code to the corresponding intermediate representation of the source code. The metadata 136 is created for specific parts of the intermediate representation (e.g., names, string values, constant values, etc.). As shown, the metadata 136 may be saved with the cached IR 134, and each of the components of the metadata 136 can be directly linked to an IR operation/value. FIG. 5 depicts exemplary metadata that may be created in connection with a small portion of source code.

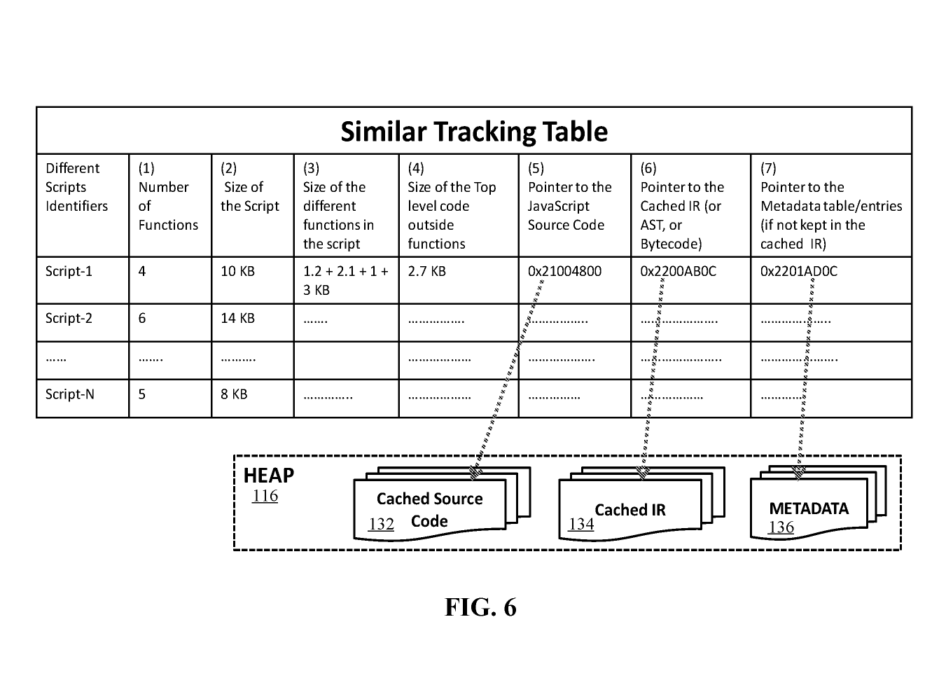

Referring again to FIG. 2, the similar match module 108 in connection with the parser 110 may maintain the similar tracking table 122 that maps all the scripts listed in the table 122 to their cached source codes 132, to their corresponding intermediate representations 134, and to their metadata 136 (Block 208). Referring to FIG. 6, shown is a similar tracking table that includes exemplary entries.

In the example depicted in FIG. 6, columns 1, 2, 3, and 4 are examples of filters and constraints that may be accessed and used to determine a reduced set of the existing scripts (and intermediate representations) with metadata in the cached source code 132, cached IR 134, and metadata 136. As shown, the similar tracking table may include accessible constraints that include: a number of functions in the cached source code relative to the received source code; a size of the cached source code relative to the received source code; a size of functions in the cached source code relative to a size of functions in the received source code; and a size of a top level code outside of functions of the cached source code relative to the received source code. These constraints may be used to find similar source code that is cached on the computing device 100.

When new source code is received at the computing device 100 that does not have an exact match in the cached source code scripts (Block 210 of FIG. 2), a script with similar source code to the received source code is searched for from among the reduced set of existing scripts in the cached source code 132 (Block 212) based on the entries in the similar tracking table 122. It should be recognized that if the exact match module 106 finds an exact match between the received new source code 104 and the cached source code scripts, then the steps associated with Blocks 212-220 need not be performed. Instead, existing state-of-art mechanisms are used. In Block 212, if no cached script is found to be similar to the newly received script, the current state of the art mechanisms of completely scanning and parsing the entire new script to the intermediate representation is done.

For example, when new JavaScript code scope is encountered during page loading, the different cached script entries in the similar tracking table 122 are compared for any similarity matches for the new script, The constraints and filters in columns 1, 2, 3, and 4 in the similarity table in FIG. 6 are used for a quick filtering to narrow down selection from the different cached scripts to determine if this new JavaScript code scope needs to be compared further with one or more cached scripts by the source code difference module 124 to obtain one or more differences between the new script and a selected cached script that is considered similar to the new script. The particular approach (to determine if a further comparison will be done) may vary from implementation to implementation. For example, one match or multiple matches in the similar tracking table 122 may enable metadata creation. It should be noted that more constraints could be used by specific implementations, then the similar tracking table 122 may have more columns for the added parameters.

In the similar tracking table depicted in FIG. 6, columns 5, 6, and 7 are pointers to source code, to the source code's cached IR, and a pointer to the metadata entry/table, respectively. It should be noted that the metadata could also be directly linked with the cached IR 134 and a set of constraint checks (e.g., within 1% size difference, a number of functions, etc). According to an aspect, the garbage collection module 118 may update the similar tracking table if any of the source code (e.g., JavaScript code) 132, the cached IR 134, or entries in the metadata 136 gets relocated or deleted by garbage collection operations.

Referring again to FIG. 2, after similar source code is found (Block 212), the received source code is compared to the similar source code to determine one or more differences between the received source code and the similar source code (Block 214). As discussed above, the cached source code 132 and received source code 104 may in the form as written by a code developer manually (with comments, spaces, tabs, and other artificial artifacts), or it may also exist in the simplified or preprocessed or compressed form where the code comments, white spaces, tabs, and various other cosmetic artifacts of writing code that do not impact the effective source code can be stripped off. The source code difference module 124 can have various optional configurations where it can be set up to partially or fully not consider these cosmetic artifacts as differences when it is computing the source code difference.

Notably, a time required to determine one or more differences between the received JavaScript code and the similar JavaScript code (Block 214) is much less than the time required for a full parsing of the JavaScript code to its intermediate representation.

An intermediate representation for the received source code is then generated by first copying and then modifying the copy of the intermediate representation of the cached source code using the metadata in connection with the one or more differences between the received source code and the similar source code (Block 220).

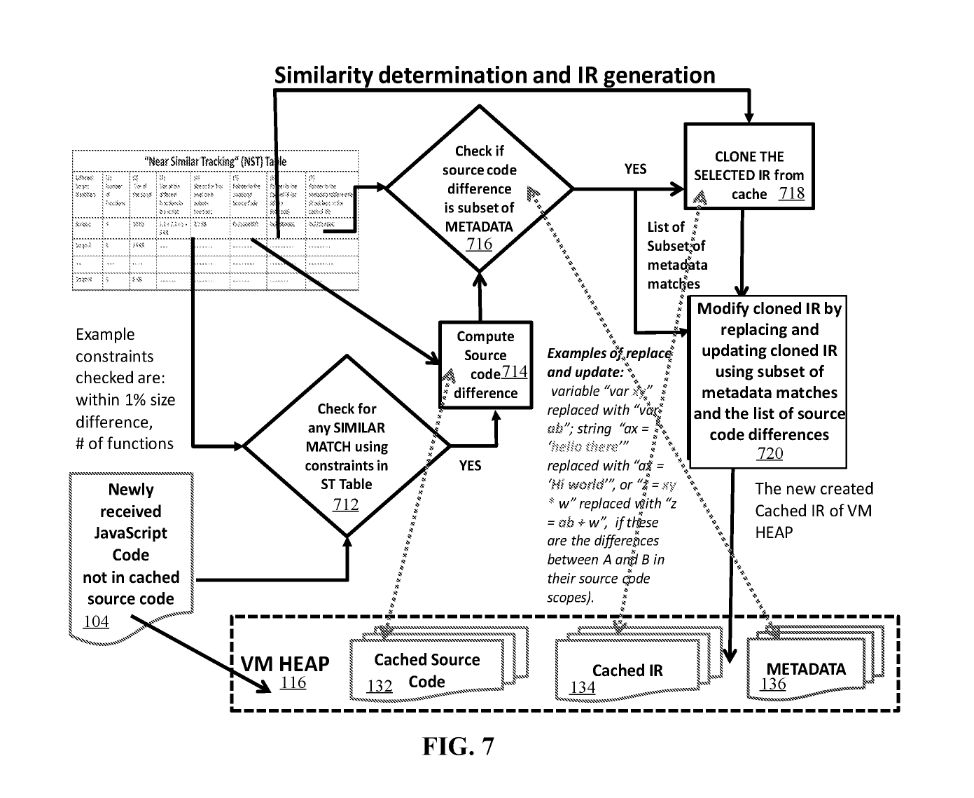

Referring to FIG. 7, shown is a process flow diagram that depicts aspects (and further details) of Blocks 210-220 of FIG. 2. As shown, when newly received JavaScript code (not existing in the cache) is introduced, the method includes checking for any similar matching JavaScript code (Block 712). This may include utilizing columns 1-4 of the similar tracking table depicted in FIG. 6, and other constraints which may be set depending upon the implementation. Next, any source code differences between the new source code and the cached source code from 132 are found (Block 714). The cached source code 132 and received source code 104 may in the form as written by a code developer manually (with comments, spaces, tabs, and other artificial artifacts), or it may also exist in the simplified or preprocessed or compressed form where the code comments, white spaces, tabs, and various other cosmetic artifacts of writing code that do not impact the effective source code can be stripped off. The source code difference module 724 can have various optional configurations where it can be set up to partially or fully not consider these cosmetic artifacts as differences when it is computing the source code difference.

Again, determining the source code difference 714 is done much faster than a full parsing of the newly received JavaScript code to its intermediate representation.

Then, the source code difference(s) is checked to determine whether the source code difference is (or correlates to) a subset of the cached metadata 136 for the cached, similar source code from 132 (Block 716). If so, the source code difference module 124 prompts a retrieval of the cached IR from 134 (that corresponds to the cached, similar source code), and the cached IR is cloned by the IR generator 126 (Block 718). An intermediate representation of the newly received source code is generated by first cloning (making a copy) the cached intermediate representation (from 134) of the matching similar code (from 132) and then modifying (e.g., replacing and updating) the cloned IR using the subset of metadata (from 136) corresponding to the cloned cached IR and the list of source code differences (Block 720). Thus, the intermediate representation for the newly received JavaScript source code is created (and is also saved in the VM Heap as an additional new cached IR in 134) without a full parsing of the JavaScript source code. If either of the steps corresponding to Blocks 712 and 716 fails, then known techniques for parsing the source code (to generate the IR code) are carried out on the received source code.

As shown in FIG. 7, the relevant parts of the cloned IR code are updated (using the metadata 136 that correlated with the source code differences) by replacing the current values in cloned cached source code (where there are differences between the received and cached source code 132) with the new values in the newly received source code to remove differences between the received source code and the similar source code. For example, a variable “var xy” in the cloned copy from the cached source code may be replaced with “var ab” that is present in the newly received source code if the source code difference indicates that the cached source has “var xy” while the new source has “var ab.” Similarly based on source code differences, a string “ax=‘hello there’” may be replaced with “ax=‘hi world’”; or “z=xy*w” may be replaced with “z=ab+w” (if these are the corresponding source code differences between the cached source code 132 and the newly received source code scopes respectively).

Further Extensions of Methodology

The methodology can be extended for differences at the level of simple JavaScript expressions and statements, when the source code difference gives enough information to construct a simple differential intermediate representation that can be then stitched in the cloned intermediate representation as a replacement of the parts belonging to the original JavaScript source code but not the new JavaScript source code.

In addition, some of the steps may be done speculatively and ahead of the time the particular JavaScript source code from the webpage needs to run. For example, the steps corresponding to Blocks 712, 714, 716, 718 and 720 may be performed speculatively ahead of time to move the processing time for these steps out of the critical path of JavaScript processing, thus providing increased performance improvement. Optionally to avoid code size growth in the JavaScript Heap 116 (e.g., due to speculative creation of cached IR code), some implementations may not perform the step corresponding to Block 720 speculatively and could limit speculation processing only for steps corresponding to Blocks 712, 714, 716, and 718.

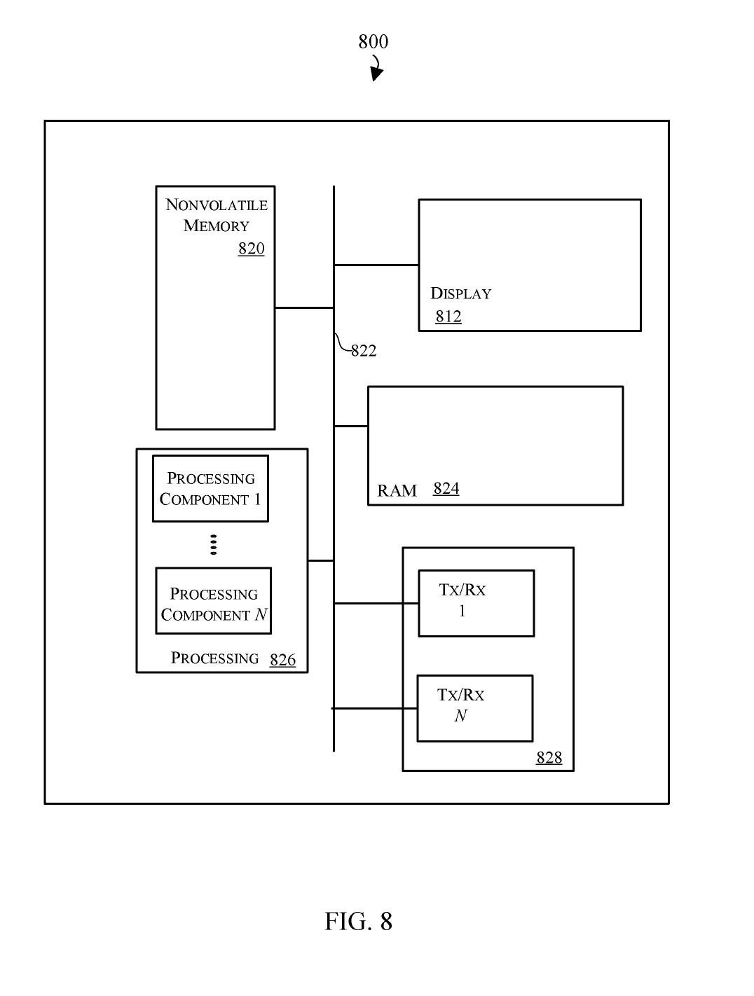

Referring next to FIG. 8, shown is a block diagram depicting physical components of an exemplary computing device 800 that may be utilized to realize the computing device 100 described with reference to FIG. 1. As shown, the computing device 800 in this embodiment includes a display 812, and nonvolatile memory 820 that are coupled to a bus 822 that is also coupled to random access memory (“RAM”) 824, N processing components 826, and a transceiver component 828 that includes N transceivers. Although the components depicted in FIG. 8 represent physical components, FIG. 8 is not intended to be a hardware diagram; thus many of the components depicted in FIG. 8 may be realized by common constructs or distributed among additional physical components. Moreover, it is certainly contemplated that other existing and yet-to-be developed physical components and architectures may be utilized to implement the functional components described with reference to FIG. 8.

The display 812 generally operates to provide a presentation of content to a user, and may be realized by any of a variety of displays (e.g., CRT, LCD, HDMI, micro-projector and OLED displays). And in general, the nonvolatile memory 820 functions as a tangible, non-transitory, computer (e.g., processor) readable storage medium to store (e.g., persistently store) data and non-transitory processor executable code including code that is associated with the functional components depicted in FIGS. 1 and 2. In some embodiments for example, the nonvolatile memory 820 includes bootloader code, modem software, operating system code, file system code, and code to facilitate the implementation of one or more portions of the virtual machine 102 discussed in connection with FIGS. 1 and 2 as well as other components well known to those of ordinary skill in the art that are not depicted nor described herein for simplicity.

In many implementations, the nonvolatile memory 820 is realized by flash memory (e.g., NAND or ONENANDTM memory), but it is certainly contemplated that other memory types may be utilized as well. Although it may be possible to execute the code from the nonvolatile memory 820, the executable code in the nonvolatile memory 820 is typically loaded into RAM 824 and executed by one or more of the N processing components 826. In many implementations, the metadata rules 130, similar tracking table 122, cached source code 132, and cached IR 134 described herein are stored in non-volatile memory 820.

The N processing components 826 in connection with RAM 824 generally operate to execute the instructions stored in nonvolatile memory 820 to effectuate the functional components depicted in FIG. 1. As one of ordinarily skill in the art will appreciate, the N processing components 826 may include an application processor, a video processor, modem processor, DSP, graphics processing unit (GPU), and other processing components.

The transceiver component 828 includes N transceiver chains, which may be used for communicating with a Web-connected network described with reference to FIG. 1. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method for generating an intermediate representation of received source code for compiling or interpreting on a computing device, the method comprising:
determining with the computing device one or more differences between received source code and similar source code cached on the computing device; and
generating an intermediate representation for the received source code by modifying a copy of an intermediate representation of the cached similar source code using metadata for the cached similar source code in connection with the one or more differences between the received source code and the cached similar source code.

2. The method of claim 1, including:
generating each time new source code is received that has neither an exact match nor a similar match on the computing device and when one or more constraints are met:
new metadata for the new source code;
an intermediate representation for the new source code;
a similar tracking table that maps the metadata to the new source code and the intermediate representation for the cached similar source code; and
caching the new source code, its intermediate representation, and its metadata.

3. The method of claim 2, wherein generating new metadata includes generating the new metadata using one or more rules relative to permissible variables, functions, properties, constants, and operators.

4. The method of claim 2, including:
finding similar source code cached on the computing device by accessing one or more entries in the similar tracking table selected from the group consisting of: a number of functions in the cached source code relative to the received source code; a size of the cached source code relative to the received source code; a size of functions in the cached source code relative to a size of functions in the received source code; and a size of a top level code outside of functions of the cached source code relative to the received source code.

5. The method of claim 2, wherein the one or more constraints include at least one constraint indicative of a time it takes to parse the new source code.

6. The method of claim 1 including:
checking whether the one or more differences is a subset of the metadata; and
copying the intermediate representation of the cached similar source code if the one or more differences is a subset of the metadata.

7. The method of claim 1, wherein modifying the copy of the intermediate representation of the cached source code includes:
replacing portions of the copy of the intermediate representation of the cached similar source code to remove the one or more differences between the received source code and the cached similar source code.

8. A computing device comprising:
a similar match module configured to find similar source code cached on the computing device that is similar to received source code;
a source code difference module configured to determine one or more differences between the received source code and the similar source code;
an intermediate representation generator configured to modify a copy of an intermediate representation of the cached similar source code using the one or more differences in connection with metadata for the cached similar source code to generate an intermediate representation for the received source code.

9. The computing device of claim 8, including:
a metadata generator configured to generate new metadata for the new source code each time new source code is received that has neither an exact match nor a similar match on the computing device and when one or more constraints are met; and
a similar tracking table that maps the new metadata to the new source code and an intermediate representation for the new source code.

10. The computing device of claim 9, wherein the metadata generator is configured to generate the new metadata using one or more rules relative to permissible variables, functions, properties, constants, and operators.

11. The computing device of claim 9, wherein the similar tracking table includes one or more constraints selected from the group consisting of: a number of functions in the cached similar source code relative to the received source code; a size of the cached similar source code relative to the received source code; a size of functions in the cached similar source code relative to a size of functions in the received source code; and a size of a top level code outside of functions of the cached similar source code relative to the received source code.

12. The computing device of claim 9, wherein the one or more constraints include at least one constraint indicative of a time it takes to parse the new source code.

13. The computing device of claim 8, wherein the source code difference module is configured to check whether the one or more differences is a subset of the metadata and prompt a retrieval of the intermediate representation of the cached similar source code if the one or more differences is a subset of the metadata.

14. The computing device of claim 8, wherein the intermediate representation generator is configured to modify the intermediate representation of the cached similar source code by:
cloning the intermediate representation of the cached source code; and
replacing portions of the cloned intermediate representation to remove the one or more differences between the received source code and the cached similar source code if the one or more differences is a subset of the cached metadata.

15. A non-transitory, tangible computer readable storage medium, encoded with processor readable instructions to perform a method for generating an intermediate representation of received source code for compiling or interpreting on a computing device, the method comprising:
determining with the computing device one or more differences between received source code and similar source code cached on the computing device; and
generating an intermediate representation for the received source code by modifying a copy of an intermediate representation of the cached similar source code using metadata for the cached similar source code in connection with the one or more differences between the received source code and the cached similar source code.

16. The non-transitory, tangible computer readable storage medium of claim 15, the method including:
generating, each time new source code is received that has neither an exact match nor a similar match on the computing device and when one or more constraints are met:
new metadata for the new source code;
an intermediate representation for the new source code;
a similar tracking table that maps the metadata to the new source code and the intermediate representation for the cached similar source code; and
caching the new source code, its intermediate representation, and its metadata.

17. The non-transitory, tangible computer readable storage medium of claim 16, wherein generating metadata includes generating the new metadata using one or more rules relative to permissible variables, functions, properties, constants, and operators.

18. The non-transitory, tangible computer readable storage medium of claim 16, the method including:
finding similar source code cached on the computing device by accessing one or more entries in the similar tracking table selected from the group consisting of: a number of functions in the cached source code relative to the received source code; a size of the cached source code relative to the received source code; a size of functions in the cached source code relative to a size of functions in the received source code; and a size of a top level code outside of functions of the cached source code relative to the received source code.

19. The non-transitory, tangible computer readable storage medium of claim 16, wherein the one or more constraints include at least one constraint indicative of a time it takes to parse the new source code.

20. The non-transitory, tangible computer readable storage medium of claim 15, the method including:
checking whether the one or more differences is a subset of the metadata; and
copying the intermediate representation of the cached similar source code if the one or more differences is a subset of the metadata.
